(19) United States
(12) Patent Application Publication
(10) Pub. No.: US 2026/0099378 A1
(43) Pub. Date: Apr. 9, 2026

(54) SYSTEM AND METHOD FOR DATA DRIVEN SCALING OF COMPUTING RESOURCE ALLOCATION VIA MACHINE LEARNING

(71) Applicant: BANK OF AMERICA CORPORATION, Charlotte, NC (US)

(72) Inventors: Annamalai Arunachalam, Singapore (SG); Frederick Borcherdt, III, Newark, DE (US); Ajai Kapur, Montville, NJ (US); Vishwanath Prasad Karra, McKinney, TX (US); William McNamara, Charlotte, NC (US); Jitesh K. Vijay, Princeton, NJ (US)

(73) Assignee: BANK OF AMERICA CORPORATION, Charlotte, NC (US)

(21) Appl. No.: 18/905,377

(22) Filed: Oct. 3, 2024

(51) Int. Cl. G06F 9/50

(52) U.S. Cl. CPC G06F 9/5055; G06F 9/5022

(57) ABSTRACT

Systems, computer program products, and methods are described herein for data driven scaling of computing resource allocation via machine learning. The present disclosure includes receiving interaction data comprising utilizing of an application and metadata, wherein the application utilizes an allocated portion of computing resources located at a server cluster, logging, in usage logs, the interaction data, determining, from the usage logs, a usage pattern associated with the application, predicting, using the usage pattern, a predicted application usage for a predetermined time, compiling the predicted application usage into a compiled application usage, and scaling, at the predetermined time and based on the compiled application usage, the allocated portion of the computing resources.

### TECHNOLOGICAL FIELD

Example implementations of the present disclosure relate to a system and method for data driven scaling of computing resource allocation via machine learning.

### BACKGROUND

In the current environment, many applications and servers within an entity are continuously running, regardless of actual user demand or utilization. The servers supplying computing power for these applications, such applications ranging from server-based software to collaborative tools like messaging and submission platforms, remain active 24/7, consuming resources even when not in active use. For instance, in an entity with a presence in different global locations, network activity may significantly vary by time of day. During off-peak hours, such as nighttime, only a small fraction of the network is active, yet all underlying servers continue to run at full capacity. This results in a situation where systems are persistently operational, sometimes for extended periods—weeks or even months—without any mechanisms to scale down or shut off during periods of low activity.

### BRIEF SUMMARY

Systems, methods, and computer program products are provided for data driven scaling of computing resource allocation via machine learning.

In one aspect, a system for data driven scaling of computing resource allocation via machine learning is presented. The system may include a processing device, and a non-transitory storage device containing instructions, when executed by the processing device, the instructions cause the processing device to perform the steps of receiving interaction data from each endpoint device within an endpoint device group, the interaction data including utilizing of an application, and metadata of at least one of a user identifier, time, location, role, weather, holidays, and current events, wherein the application utilizes an allocated portion of computing resources located at a server cluster, the allocated portion being specific to the application and scalable, logging, in usage logs, the interaction data, determining, from the usage logs, a usage pattern associated with the application, the usage pattern including extracted trends and an impact on the utilization of the application based on the extracted trends, predicting, using the usage pattern, a predicted application usage for a predetermined time, compiling the predicted application usage into a compiled application usage, and scaling, at the predetermined time and based on the compiled application usage, the allocated portion of the computing resources.

In some implementations, the instructions may further cause the processing device to perform the steps of receiving, a request for additional computing resources during the predetermined time from an endpoint device of the endpoint device group, analyzing the request for the additional computing resources, and re-scaling, in response to the request for the additional computing resources, the allocated portion of the computing resources.

In some implementations, the instructions may further cause the processing device to perform the steps of receiving news data from a news data feed, wherein the news data may include an outage report, re-scaling the allocated portion of the computing resources based on the news data.

In some implementations, the instructions may further cause the processing device to perform the steps of causing to be displayed on an endpoint device of the endpoint device group, a dashboard, the dashboard displaying a computing resource usage rate for the application, endpoint device quantity, and a listing of other applications, wherein computing resources are in a datacenter, the dashboard displays datacenter specific views and a utilization percentage of the datacenter, and the dashboard displays a regional breakdown of regional computing resource usage.

In some implementations, the dashboard displays server efficiency, and computing resource allocation may be modified based on the server efficiency.

In some implementations, scaling the allocated portion of the computing resources may include at least one of (i) turning on or off processors of the computing resources, (ii) adding or removing route servers, and (iii) re-allocating computing resources to the application.

In some implementations, the metadata may be at least partially provided by a work portal database.

In another aspect, a computer program product for data driven scaling of computing resource allocation via machine learning is presented. The computer program product including a non-transitory computer-readable medium including code causing an apparatus to receive interaction data from each endpoint device within an endpoint device group, the interaction data including utilizing of an application, and metadata of at least one of a user identifier, time, location, role, weather, holidays, and current events, wherein the application utilizes an allocated portion of computing resources located at a server cluster, the allocated portion being specific to the application and scalable, log, in usage logs, the interaction data, determine, from the usage logs, a usage pattern associated with the application, the usage pattern including extracted trends and an impact on the utilization of the application based on the extracted trends, predict, using the usage pattern, a predicted application usage for a predetermined time, compile the predicted application usage into a compiled application usage, and scale, at the predetermined time and based on the compiled application usage, the allocated portion of the computing resources.

In some implementations, the code may further cause the apparatus to receive, a request for additional computing resources during the predetermined time from an endpoint device of the endpoint device group, analyze the request for the additional computing resources, and re-scale, in response to the request for the additional computing resources, the allocated portion of the computing resources.

In some implementations, the code may further cause the apparatus to receive news data from a news data feed, wherein the news data may include an outage report, re-scale the allocated portion of the computing resources based on the news data.

In some implementations, the code may further cause the apparatus to cause to be displayed on an endpoint device of the endpoint device group, a dashboard, the dashboard displaying a computing resource usage rate for the application, endpoint device quantity, and a listing of other applications, wherein computing resources are in a datacenter, the dashboard displays datacenter specific views and a utilization percentage of the datacenter, and the dashboard displays a regional breakdown of regional computing resource usage.

In some implementations, the dashboard displays server efficiency, and computing resource allocation may be modified based on the server efficiency.

In some implementations, scaling the allocated portion of the computing resources may include at least one of (i) turning on or off processors of the computing resources, (ii) adding or removing route servers, and (iii) re-allocating computing resources to the application.

In some implementations, the metadata may be at least partially provided by a work portal database.

In yet another aspect, a method for data driven scaling of computing resource allocation via machine learning is presented. The method may include receiving interaction data from each endpoint device within an endpoint device group, the interaction data including utilizing of an application, and metadata of at least one of a user identifier, time, location, role, weather, holidays, and current events, wherein the application utilizes an allocated portion of computing resources located at a server cluster, the allocated portion being specific to the application and scalable, logging, in usage logs, the interaction data, determining, from the usage logs, a usage pattern associated with the application, the usage pattern including extracted trends and an impact on the utilization of the application based on the extracted trends, predicting, using the usage pattern, a predicted application usage for a predetermined time, compiling the predicted application usage into a compiled application usage, and scaling, at the predetermined time and based on the compiled application usage, the allocated portion of the computing resources.

In some implementations, the method may further include receiving, a request for additional computing resources during the predetermined time from an endpoint device of the endpoint device group, analyzing the request for the additional computing resources, and re-scaling, in response to the request for the additional computing resources, the allocated portion of the computing resources.

In some implementations, the method may further include receiving news data from a news data feed, wherein the news data may include an outage report, re-scaling the allocated portion of the computing resources based on the news data.

In some implementations, the method may further include causing to be displayed on an endpoint device of the endpoint device group, a dashboard, the dashboard displaying a computing resource usage rate for the application, endpoint device quantity, and a listing of other applications, wherein computing resources are in a datacenter, the dashboard displays datacenter specific views and a utilization percentage of the datacenter, and the dashboard displays a regional breakdown of regional computing resource usage.

In some implementations, the dashboard displays server efficiency, and computing resource allocation may be modified based on the server efficiency.

In some implementations, scaling the allocated portion of the computing resources may include at least one of (i) turning on or off processors of the computing resources, (ii) adding or removing route servers, and (iii) re-allocating computing resources to the application.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for data driven scaling of computing resource allocation via machine learning, in accordance with an implementation of the disclosure;

FIG. 2 illustrates an exemplary machine learning model subsystem architecture, in accordance with an implementation of the disclosure; and

FIGS. 3A-3C illustrate a process flow for data driven scaling of computing resource allocation via machine learning, in accordance with an implementation of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on. ” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model to perform functions as a foundation for the larger piece of software that drives the functionality of the software. The machine learning model for any given engine may be self-contained (e.g., without interaction with other engines), or the machine learning model may be shared across one or more engines. In other words, some implementations of the larger piece of software many implement multiple machine learning models to perform functions of the various engines. In other implementations, a single machine learning model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

The continuous operation of servers to support applications leads to significant inefficiencies in resource utilization. All systems involved in supporting these applications are constantly consuming compute resources, such as CPU, memory, and disk storage, regardless of the actual demand. The inability to dynamically manage application states or server loads based on real-time usage patterns results in a constant draw on computational resources, driving up energy consumption and associated costs. The problem is compounded in large-scale environments where thousands of servers and applications are involved, leading to excessive power usage, increased hardware wear and tear, and a lack of effective energy-saving measures. The challenge lies in developing a system capable of intelligently managing application lifecycles and server loads to minimize unnecessary resource consumption.

Current solutions for managing application and server usage within entities are inadequate because they lack dynamic control over the resource allocation based on real-time user demand. Most systems are designed to remain operational continuously without any built-in intelligence to scale resources up or down when demand increases or drops. This leads to inefficiencies, such as unnecessary power consumption, over-utilization of hardware, and increased operational costs. While some entities attempt to address these issues with manual scheduling or rudimentary automation scripts, these approaches are often inflexible, error-prone, and require constant administrative oversight. Without a comprehensive solution to dynamically optimize resource utilization and manage energy consumption, entities face significant sustainability challenges and increased operational costs.

Addressing these challenges requires the establishment of a system and method for data driven scaling of computing resource allocation via machine learning, which provide for the implementation of a machine learning model to predict and allocate, based on interaction data collected in combination with metadata regarding application use, computing resources for specific computer applications and therefore conserve energy and reduce inefficient use of computing resources. The prediction results in the scaling, on a continuous basis, the amount of computing resources required for each application, individually, such that a minimal amount computing resources are allocated to each application, thereby conserving energy and increasing efficiency.

To do so, interaction data may be received from endpoint devices of a group of endpoint devices (i.e., an endpoint device group). The interaction data may include how often an application is utilized, as well as metadata associated with this utilization. The metadata received could be user identifier(s) such as usernames and other identifiers, time(s) of utilization including time zones, start, stop, etc., location(s) of the application utilization, including geographic identifiers, entity campus location, role, including job title, permissions, or the like, weather, including weather events, past weather, and/or forecasts for the location of the endpoint device during application utilization, holidays related to the location(s) of the endpoint device during application utilization and/or user identifier(s), and current events. This type of metadata may be provided by a work portal database, obtained from an endpoint device, or the like, or combinations thereof. The interaction data may be logged in usage logs, which are then used to determine a usage pattern which may include extracted trends and impact on the utilization of the application based on such extracted trends. A predicted application usage may be predicted using the usage pattern, this predicted application usage being compiled along with that of the other users within the application group or endpoint devices within the endpoint device group to obtain a compiled application usage. Based on this compiled usage, the system may scale the allocated portion of computing resources, since the application utilizes an allocated portion of computing resources located at a server cluster. This scaling may occur at a predetermined time and/or at predetermined intervals. A dashboard having a computing resource usage rate for the application may be displayed on an endpoint device, as well as other quantitative and qualitative measures, including endpoint device quantity utilizing the application, listing of other applications, datacenter specific views and a utilization percentage of the datacenter, regional breakdowns of regional computing resource usage, server efficiency, and so forth. Through the dashboard or through another interface, a request for additional computing resources may be received, which may result in re-scaling of the computing resources. Other methods of re-scaling the computing resources may rely on news data from a news feed containing an outage report.

What is more, the present disclosure provides a technical solution to a technical problem. As described herein, the technical problem includes the inability to manage application states or server loads, resulting in a constant draw on computational resources, which drives up energy consumption and associated costs. The present disclosure embraces an improvement over existing solutions by allowing for the improvement in efficiency of computing resource usage (i) with fewer steps to achieve the solution (e.g., allowing the machine learning model to directly adjust allocated resources for an application on an ongoing basis, without the need for continuous evaluation and re-allocation), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., by eliminating over-allocation waste or under-allocation disasters using a machine learning model to make predictions and allocate computing resources to applications), (iii) removing manual input and waste from the implementation of the solution, thus improving speed and efficiency of the process and conserving network resources (e.g., avoiding the manual allocation of computing resources by leveraging a machine learning model), (iv) determining an optimal amount of resources that need to be used to implement the solution, thus reducing network traffic and load on existing network resources (e.g., minimizing the allocation of computing resources to applications that are unnecessary at a given time). In other words, the solution may bypass a series of steps previously implemented, thus further conserving network resources. Furthermore, the technical solution described herein uses a rigorous, computerized process to perform specific tasks and/or activities that were not previously performed.

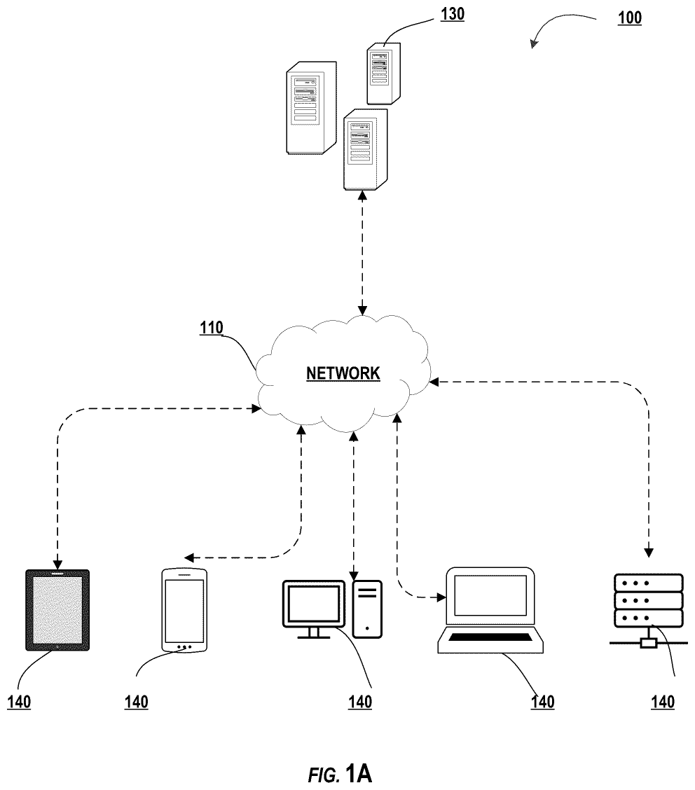

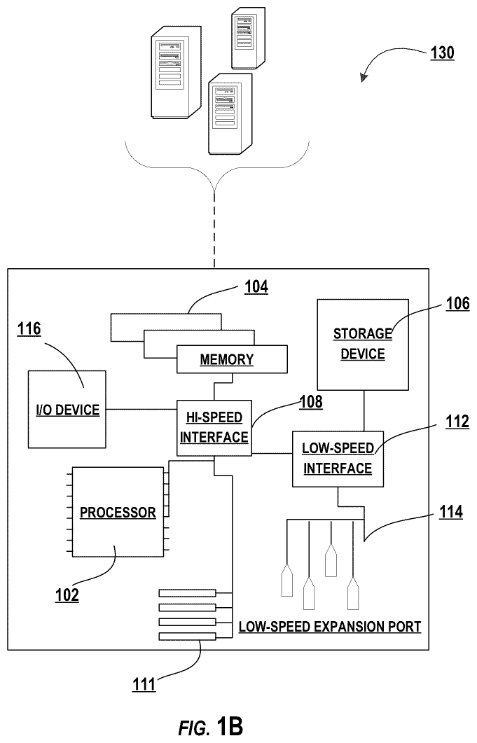

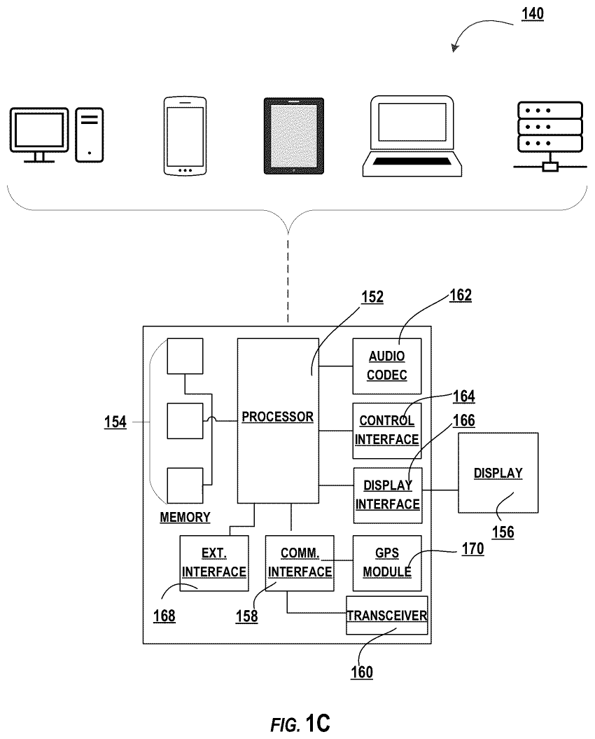

FIGS. 1A-1C illustrate technical components of an exemplary distributed computing environment 100 for data driven scaling of computing resource allocation via machine learning, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

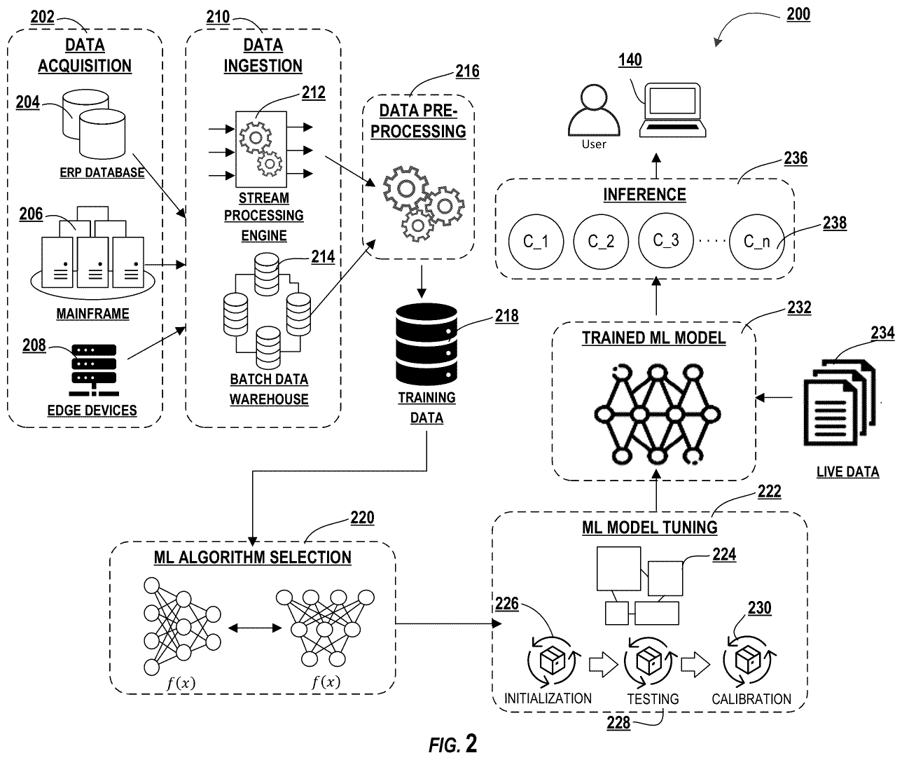

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other applications. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2. . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2. . . C_n 238) live data 234 based on how similar they are to one another to solve exploratory challenges where little is known about the data, provide a description or label (e.g., C_1, C_2. . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

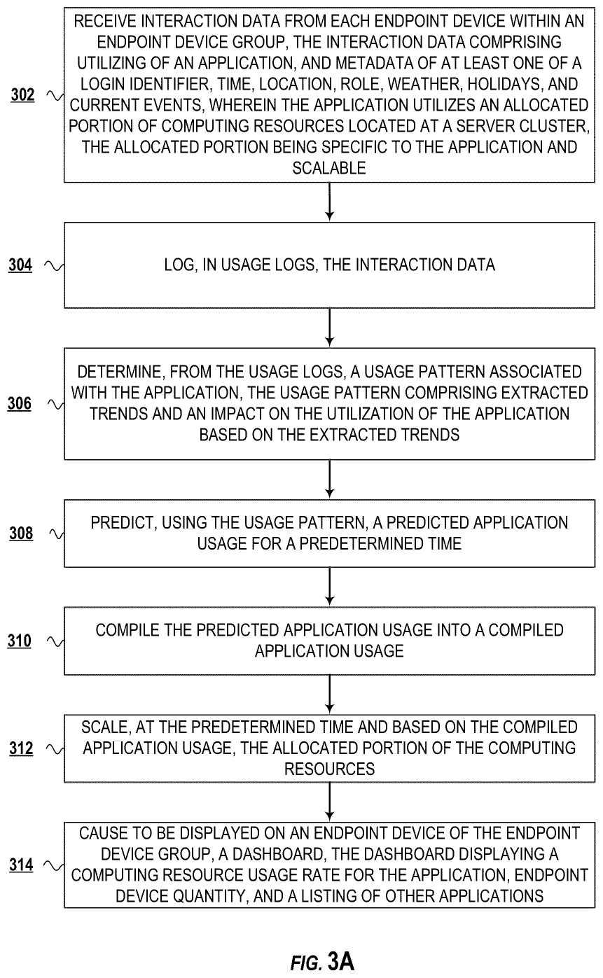

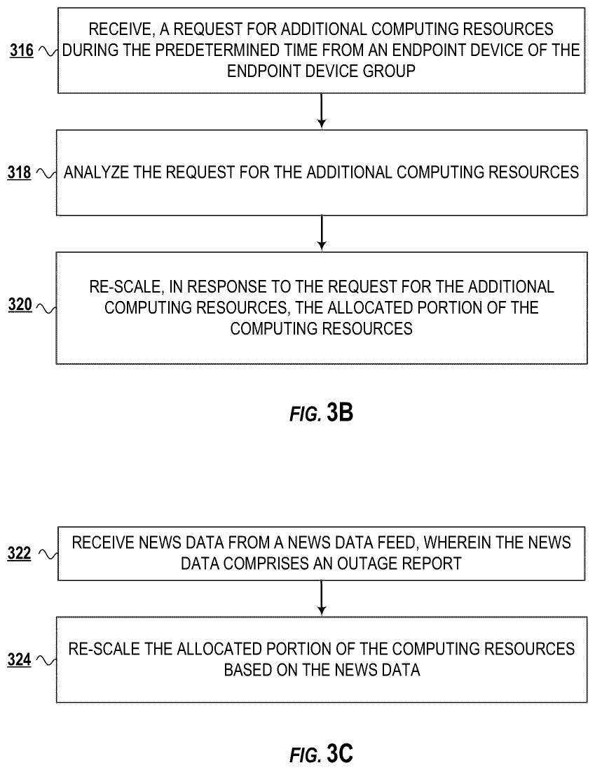

FIGS. 3A-3B illustrate a process flow for data driven scaling of computing resource allocation via machine learning, in accordance with an implementation of the disclosure. At block 302, the system may receive interaction data from endpoint devices within an endpoint device group.

Groups of endpoint devices (i.e., endpoint device groups) may be defined in any number of ways and refers generally to a population of endpoint devices. The endpoint device group may be classified as every endpoint device within a computing environment of an entity, every endpoint device within a computing environment of a local branch of an entity, a subset of endpoint devices within the computing environment of an entity (e.g., all computing devices belonging to a particular job group, title, or other designation), a population of endpoint devices across a plurality of entities, or the like.

A “user group” as used herein may refer to any predefined population of users (e.g., their corresponding user identifiers). For example, in some implementations, a user group may refer to all users within an entity. In other implementations, a user group may refer to users of an entity in a designated office, geographic area, role, group, or otherwise.

As used herein, “interaction data” may refer to any data generated from the use/utilization of an application (e.g., a computer program) on an endpoint device, including, but not limited to, user inputs, commands, clicks, keystrokes, screen touches, application usage patterns, system logs, error reports, performance metrics, and any other form of data reflecting the interaction between the user and the application.

In some implementations, each user of the user group may be associated with a single endpoint device of the endpoint device group. In other implementations, a user of the user group may have more than one, or less than one, endpoint device with which said user is associated. Thus, in some examples, interaction data may be collected and associated with the endpoint device (e.g., with metadata associated with the endpoint device on which it was collected), while additionally, or alternatively, the interaction data may be collected and associated with a user of a user group (e.g., via a user identifier as metadata).

Metadata may be associated with the interaction data, either inherently (e.g., generated upon the interaction event that results in interaction data), or may be associated with the interaction data by the system described herein. This metadata may serve to correspond the interaction data with qualitative and quantitative characteristics of the user generating such interaction data, the endpoint device on which the interaction data is generated, and so forth (e.g., extracted features). Examples of such metadata include a user identifier (e.g., a user ID for login to an entity system, email address, etc.), time (e.g., clock time of the generation of the interaction data, clock time of starting and/or stopping the generation of interaction data, time zone information, etc.), location (e.g., coordinates determined upon collection of geolocation data from a geolocation device, inferred from IP address information, inferred from a role within the entity, inferred from a network to which the endpoint device is connected, etc.), role (e.g., job title, entity job group to which the user is assigned, job function, description, number of direct reports, etc.), weather (e.g., weather forecasts and/or current conditions obtained from live weather forecast applications, climate trends obtained from historical climate databases, etc.), holidays (obtained from a database or calendar of holidays for a determined location, obtained from a shared calendar or database managed by the entity related a specific user identifier to communicate time away from engaging in work activities, etc.), and current events (determined via a data stream from news sources, APIs provided by news agencies or social media platforms, web scraping, RSS feeds, integration with third-party applications that provide news data, etc.), and so forth. Indeed, other example of metadata are also contemplated, including metadata generated by interaction with other applications or hardware of an endpoint device.

In some implementations, the metadata may be at least partially provided by a work portal database. A work portal database may be a database maintained by an entity, with or without intervention and modification by a user, that describes a user's role within the entity, including their title, responsibilities, main office campus location, access permissions, and interactions with various systems. The database may also store data such as project assignments, performance metrics, communication logs, work calendar, data regarding log-in and log-off times, and so forth.

As one non-limiting example, a user may log-in to an endpoint device, thereby generating metadata regarding the time of log-in, the user identifier used for log-in, etc., as well as location data collected from a GPS module of the endpoint device upon log-in. Once the user navigates to Application A, and launches Application A, interaction data and/or metadata may be stored and/or generated indicating the time of interaction with Application A, and the frequency of the user engaging in predetermined tasks within Application A. Once the user closes Application A, interaction data and/or metadata may be stored and/or generated indicating the time that interaction with Application A ceases.

Indeed, many such examples are contemplated based on combinations of the foregoing interaction data and metadata, and such interaction data and metadata may be applicable to any given application of a computing environment.

Furthermore, any given application of the type for implementation of the disclosure herein may utilize an allocated portion of computing resources of a server cluster.

In traditional systems, Application A may be allocated computing resources of a server cluster by being deployed within a virtual machine or container environment, by having a resource quota predefined for the application, or the like.

In contrast, the disclosure of implementations described herein is related to the assignment of computing resources for an application as a tenant of a server cluster, where the computing resources and/or the assigned server cluster may change over time based on a predicted demand. Importantly, the allocation of the computing resources to a given application may be scalable such that computing resources assigned to an application increase over time (i.e., more computing resources), decrease over time (i.e., fewer computing resources), stay constant over time, or combinations of any of the foregoing over a given time period.

Allocated portion(s) of server cluster(s) may be specific to the application. For example, Server cluster 1 may include portions of computing resources allocated to Application A, Application B, and Application C. As a result of the process described herein, at a given Time X, for example, Application A may be allocated 80% of the computing resources of the server cluster, Application B may be allocated 15% of computing resources of the server cluster, and Application C may be allocated 5% of computing resources of the server cluster. At a given Time Y, however, Application A may be allocated 50% of the computing resources of the server cluster, Application B may be allocated 30% of computing resources of the server cluster, and Application C may be allocated 20% of computing resources of the server cluster. Similarly, at a given Time Z, Application A may be allocated 20% of the computing resources of the server cluster, Application B may be allocated 70% of computing resources of the server cluster, and Application C may be allocated 10% of computing resources of the server cluster. Indeed, over any given time period, the allocation of computing resources of the server cluster may vary for the various applications supported by the server cluster, as a result of the processes described herein.

At block 304, the system may log, in usage logs, the interaction data. As a means for structuring the interaction data, usage logs may be created and populated with interaction data. In some implementations, each application may have its own corresponding usage log that contains interaction data, organized in columns and rows by user identifier, such that the usage of said application is easily ascertained across an entire population of endpoint devices. Additionally, or alternatively, usage logs may be organized by region, entity, job title, or the like. In some implementations, a usage log may contain interaction data associated with a plurality of applications.

At block 306, the system may determine a usage pattern associated with an application. The determining of a usage pattern stems from analysis of the usage logs, the analysis involving unsupervised learning and/or feature extraction including clustering, principal component analysis (“PCA”), or anomaly detection to identify patterns or groupings. Clustering algorithms, for example, may group similar data points of the usage logs together based on their features, and reveal natural divisions within the data. PCA may reduce dimensionality and make patterns more visible. Anomaly detection may identify data points that deviate from established patterns and highlight areas of interest. These methods may enable the recognition of patterns within the usage logs, which will be used in combination with prediction mechanisms described herein with respect to block 308.

The usage pattern, once determined, may reveal extracted trends and an impact on the utilization of the applications analyzed based on these extracted trends. For example, an extracted trend could be that endpoint devices (and usage of an application thereon) or users in certain time zone are unlikely to be active during certain hours, or that endpoint devices (and usage of an application thereon) or users are likely to be inactive during certain weather conditions. Additionally, or alternatively, endpoint devices or users associated with certain user identifiers or job titles may be less likely to use a particular application during a given season. Indeed, numerous extracted trends are contemplated, any of which could relate to the metadata applied/created as described earlier in the present process.

Continuing at block 308, the system may predict, using the usage pattern, a predicted application usage. The predicted application usage (e.g., for what length of time and/or how many computing resources for a given endpoint device) may be accomplished using a machine learning model. In instances where a machine learning model is implemented elsewhere in the system, the machine learning model for predicting the application usage may be the same or different than the other machine learning model(s).

In some implementations, the predicted application usage may be predicted for each endpoint device of the endpoint device group. In other implementations, the predicted application usage may be predicted for each user of the user group, as each user of the user group may be associated with one, more than one, or less than one, endpoint device.

The machine learning model, upon being prompted (either automatically or manually) to determine a predicted application usage of an application, may use regression analysis, decision trees, neural network(s), time series models, and/or other supervised learning techniques on the usage pattern to predict the application usage of the application for either the user or the endpoint device.

This usage may include estimated duration of use of the application, estimated computing resource usage (at the server cluster, and/or at the endpoint device itself) during the duration of use or other predetermined time interval, or the like.

The predicted application usage may be specific to a predetermined time (i.e., a time period in the future for which the predicted application usage is desired). The predetermined time may be several minutes from the present moment, hours, days, weeks, months, or the like. The predetermined time may also be a series of time intervals in the future, for example multiple consecutive days, alternating weeks, or a sequence of monthly periods, such as the first and third week of each month, or non-consecutive intervals, such as the 5th day of one month and the 20th day of the next, or the like. Similarly, the predetermined time may be a range of hours, consecutive or disparate from one another. For example, the predetermined time may be 9 am-6 pm for each consecutive day of the week for the next several weeks, or consecutive segments of time such as each consecutive hour for the next 8 weeks.

At block 310, the system may compile the predicted application usage (or predicted application usages, if multiple time intervals are defined to be the predetermined time) into a compiled application usage. In some implementations, the present disclosure contemplates aggregating the predicted application usage for each endpoint device or user within respective user groups or endpoint device groups, in an effort to predict the total usage for a given application across the user group or endpoint device group. To do so, individual calculations of predicted application usage for each user or endpoint device may be required, followed by summing together all those within a group. For example, predicted application usages for each user of a plurality of users within a user group may be compiled together for the whole user group. Alternatively, predicted application usages for each endpoint device within an endpoint device group may be compiled together for the whole endpoint device group.

However, in other implementations, the present disclosure embraces the predicted application usage being predicted for the user group or endpoint device group as a whole. In other words, instead of predicting the predicted application usage for a singular user or endpoint device, a predefined user group or predefined endpoint device group may be provided to the machine learning model, such that the machine learning model may be queried to provide the predicted application usage for the endpoint device group or user group.

Once a compiled application usage has been determined, at block 312, the system may scale the allocated portion of the computing resources. The scaling of the allocated portion of the computing resources may be at the predetermined time and may be based on the compiled application usage. The compiled application usage may be interpreted to be the amount of computing resources at the server cluster(s) necessary to provide user/endpoint devices across the user group/endpoint device group with consistent access and usage of the application without over-allocation of computing resources (leading to wasteful energy consumption or unnecessary server clusters) or under-allocation of computing resources (leading to application bandwidth shortages, failures, etc.).

Thus, at the predetermined time, or at predefined intervals throughout the predetermined time as specified, the allocated portion of the computing resources may be increased or decreased at the server cluster to align with the compiled application usage. In some implementations, the allocated portion of the computing resources at the server cluster may be increased or decreased to match the compiled application usage exactly (e.g., if 15 TB of memory is required as designated by the compiled application usage, 15 TB of memory may be allocated). In other implementations, the allocated portion of the computing resources at the server cluster may be increased or decreased a predetermined percentage of the compiled application usage (e.g., if 15 TB of memory is required as designated by the compiled application usage, 16.5 TB of memory may be allocated, representing an increase of 10% in favor of over-allocation).

In some implementations, to scale the allocated portion of the computing resources, the system may turn on or off processors of the computing resources at the server cluster. Additionally, or alternatively, the system may add or remove route servers. Additionally, or alternatively, the system may re-allocate existing computing resources at the server cluster to the application.

It shall be appreciated that scaling of the allocated portion of the computing resources may include transferring some or all of the allocated portion of the resources to a secondary server cluster. Indeed, while in some implementations a single server cluster may provide all of the computing resources for an application, in other implementations these computing resources may be split amongst a plurality of server clusters. As such, scaling may include removing one of the plurality of server clusters from providing computing resources for the application, or adding a server cluster for providing the computing resources for the application. Additionally, or alternatively, scaling may include transferring allocated portions of computing resources from one server cluster to a different server cluster. For example, it may be determined that some server clusters should be given priority (e.g., from a predetermined priority list) such that a server cluster with a higher priority should be assigned allocated portion(s) of resources for one or more applications to maximize the usage of available computing resources on said higher priority server cluster before assigning allocated portions(s) of resources to other, lower priority server cluster(s). By way of example, some server clusters may be more energy efficient than others, more consistent than others, faster than others, or the like, and as such may be placed in a higher priority position than other server clusters.

While the foregoing processes may occur entirely in the background of a computing environment, it may also be beneficial in some implementations to display graphics containing details of the usage rate of application(s), the allocation of computing resources for the application(s), or the like, in order to provide administrators with high level overviews of the computing environment and/or control interface mechanisms to make adjustments to various parameters as-needed, as will be described in detail herein.

As such, at block 314, the system may cause to be displayed on an endpoint device, a dashboard. In some implementations, the endpoint device(s) on which the dashboard is displayed may be one of the endpoint device(s) from which interaction data was received at block 302, while in other implementations the endpoint device on which the dashboard is displayed may be entirely independent, such as an endpoint device of an administrator for the entity.

Numerous configurations of the dashboard are contemplated, including a dashboard that displays computing resource usage rate for the application (e.g., amount of memory across the entity computing environment that a particular application or group of applications is currently using, used in the past, and/or predicted for the future). This usage rate may be displayed as a meter with a numerical output corresponding to the amount of memory used or may be formatted as a line chart with one axis representing time. Additionally, or alternatively, the dashboard may display the computing resource allocation for an application(s). In this way, the computing resource usage rate for the application may be compared to that which was allocated to view accuracy of the prediction of block 308.

Additionally, or alternatively, the dashboard may display the quantity of endpoint devices currently utilizing an application, or a quantity of endpoint devices in the past that used the application or future that are predicted to use the application. Additionally, or alternatively, by implementing the location metadata obtained in block 302, endpoint devices currently using a given application may be displayed on a map to provide an overview of geographical regions that are using the application at a given time as a heatmap. Additionally, or alternatively, the dashboard may display a listing of various other applications used throughout the entity computing environment, usage of said applications, predicted usage, endpoint device quantity and location, or any other metric detailed herein.

In some implementations, computing resources and the allocated portions thereof are in a datacenter (e.g., a physical location that contains the server cluster(s)), the dashboard may display a rendering or graphical representation of the physical layout of the datacenter, with each server being represented in the graphical representation, along with utilization percentage of each server (including the application(s) to which the computing resources of the server are allocated). Similarly, the utilization percentage of the aggregated computing resources for all the servers in a datacenter as whole (including the application(s) to which the computing resources of the datacenter are allocated) may be represented in the graphical representation.

Additionally, or alternatively, the dashboard may display a regional breakdown of regional computing resource usage. For example, the dashboard may include a chart showing a geographical region (e.g., Country A, Country B, etc., State A, State B, etc., City A, City B, etc., and so forth) and a utilization percentage of each server cluster within the designated geographical region. In this way, computing resource utilization in particular geographic areas may be avoided or promoted, depending on circumstances.

Additionally, or alternatively, the dashboard may display server efficiency, and computing resource allocation may be modified based on the server efficiency. As previously described, some server clusters may be more energy efficient than others, more consistent than others, faster than others, or the like, and as such may be placed in a higher priority position than other server clusters. Server clusters may be incorporated with corresponding power meters to measure current draw (i.e., energy consumption) of each server cluster. Based on predetermined characteristics of each server cluster (e.g., total computing power) and the identified utilization percentage, the efficiency of the server cluster may be represented numerically. For example, efficiency may be calculated as the product of total computing power multiplied by utilization percentage, said product being divided by the energy consumption rate. Computing resource allocation may be increased or decreased for a given server cluster based on the efficiency. In some implementations, the increasing or decreasing may be performed manually. In other implementations, the increasing or decreasing may be performed by a machine learning model trained to re-allocate computing resource allocation to the most efficient server clusters in real-time, as a result of the ongoing calculation of efficiency at a predetermined interval.

Continuing at block 316 of FIG. 3B, the system may receive a request for additional computing resources during the predetermined time from an endpoint device of the endpoint device group. In some implementations, the endpoint device referred to in block 316 may be different from one on which a dashboard is displayed, and may instead be an endpoint device using an application. In other implementations the endpoint device may be the same endpoint device referred to in block 314 (e.g., an endpoint device of an administrator with an overview of application utilization). It shall be appreciated that an endpoint device currently using an application (and creating interaction data of block 302) may experience shortcomings, errors, sluggishness, or otherwise less-than-adequate functioning of the application. Accordingly, an application (or the dashboard) of the endpoint device of block 316 may include a button or interactive element that transmits a signal that additional computing resources may be needed for the application.

As a result, the system may receive this signal and analyze the request at block 318, including details of the requesting endpoint device (e.g., location, application that the requesting endpoint device is attempting to use, or the like, as may be provided through any metadata that may accompany the signal). Based on the application identified to be that which the endpoint device is attempting to use, the system may identify the allocated portion of the computing resources specific to said application. The system may also determine the server cluster(s) on which the allocated portion of the computing resources are designated, such as to determine if any additional computing resources are available for allocation to the application.

Accordingly, at block 320, the system may re-scale the allocated portion of the computing resources in response to the request for the additional computing resources. For example, in response to receiving the signal that additional computing resources may be needed for the application, if additional computing resources are available, the system may allocate those additional computing resources to the application. In some implementations, a predetermined percentage increase may be specified, such that the total allocated computing resources for the application increases by the predetermined percentage. In other implementations, a predetermined amount of memory may be specified instead of the predetermined percentage. In yet additional implementations, the re-scaling the allocated portion of the computing resources may be a complete removal of any allocation, such that the application may be able to use as many computing resources as needed by the application for a predetermined amount of time.

Continuing at block 322 at FIG. 3C, the system may receive news data from a news data feed, wherein the news data may include an outage report. It shall be appreciated that various calamities, whether within the entity, locally, or throughout the globe, may impact the usage of an application (e.g., by increasing demand to use the application, decrease demand to use the application), limit the availability of server clusters(s)(e.g., by unexpected interruptions to the connectivity thereto), and so forth. As such, news data feeds may be implemented to receive real-time information regarding events that may impact these factors.

News data feed(s) may be provided to the system via one or more APIs to news sites, RSS feeds, web scraping, social media monitoring, or the like. The system may ingest and parse news feed data to extract relevant textual information such as headlines, summaries, and articles. The system may then apply Natural Language Processing (NLP) to identify keywords, phrases, or entities indicative of events related to computer availability, like “cyberattack” or “power outage. ” Using NLP techniques, the system may then analyze the context of these keywords to determine whether the described event may negatively impact application availability. The event is then classified by a pre-trained machine learning model into specific types, such as cyberattacks or natural disasters, based on the extracted data. The system may then assess the potential impact by correlating the event with relevant locations (e.g., of server clusters) or applications, and flag those likely to influence application availability. As a result, at block 324, the system may then re-scale the allocated portion of the computing resources based on the news data. This re-scaling may include increasing or decreasing the allocated portion of the computing resources by a predetermined percentage or amount, as described herein, transferring the allocated portion of the computing resources from one server cluster to another server cluster, and so forth.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for data driven scaling of computing resource allocation via machine learning, the system comprising:
a processing device; and
a non-transitory storage device containing instructions, when executed by the processing device, the instructions cause the processing device to perform the steps of:
receiving interaction data from each endpoint device within an endpoint device group, the interaction data comprising utilizing of an application, and metadata of at least one of a user identifier, time, location, role, weather, holidays, and current events, wherein the application utilizes an allocated portion of computing resources located at a server cluster, the allocated portion being specific to the application and scalable;
logging, in usage logs, the interaction data;
determining, from the usage logs, a usage pattern associated with the application, the usage pattern comprising extracted trends and an impact on the utilization of the application based on the extracted trends;
predicting, using the usage pattern, a predicted application usage for a predetermined time;
compiling the predicted application usage into a compiled application usage; and
scaling, at the predetermined time and based on the compiled application usage, the allocated portion of the computing resources.

2. The system of claim 1, wherein the instructions further cause the processing device to perform the steps of:
receiving, a request for additional computing resources during the predetermined time from an endpoint device of the endpoint device group;
analyzing the request for the additional computing resources; and
re-scaling, in response to the request for the additional computing resources, the allocated portion of the computing resources.

3. The system of claim 1, wherein the instructions further cause the processing device to perform the steps of:
receiving news data from a news data feed, wherein the news data comprises an outage report;
re-scaling the allocated portion of the computing resources based on the news data.

4. The system of claim 1, wherein the instructions further cause the processing device to perform the steps of:
causing to be displayed on an endpoint device of the endpoint device group, a dashboard, the dashboard displaying a computing resource usage rate for the application, endpoint device quantity, and a listing of other applications;
wherein computing resources are in a datacenter, and wherein the dashboard displays datacenter specific views and a utilization percentage of the datacenter; and
wherein the dashboard displays a regional breakdown of regional computing resource usage.

5. The system of claim 4, wherein the dashboard displays server efficiency, and wherein computing resource allocation is modified based on the server efficiency.

6. The system of claim 1, wherein scaling the allocated portion of the computing resources comprises at least one of (i) turning on or off processors of the computing resources, (ii) adding or removing route servers, and (iii) re-allocating computing resources to the application.

7. The system of claim 1, wherein the metadata is at least partially provided by a work portal database.

8. A computer program product for data driven scaling of computing resource allocation via machine learning, the computer program product comprising a non-transitory computer-readable medium comprising code causing an apparatus to:
receive interaction data from each endpoint device within an endpoint device group, the interaction data comprising utilizing of an application, and metadata of at least one of a user identifier, time, location, role, weather, holidays, and current events, wherein the application utilizes an allocated portion of computing resources located at a server cluster, the allocated portion being specific to the application and scalable;
log, in usage logs, the interaction data;
determine, from the usage logs, a usage pattern associated with the application, the usage pattern comprising extracted trends and an impact on the utilization of the application based on the extracted trends;
predict, using the usage pattern, a predicted application usage for a predetermined time;
compile the predicted application usage into a compiled application usage; and
scale, at the predetermined time and based on the compiled application usage, the allocated portion of the computing resources.

9. The computer program product of claim 8, wherein the code further causes the apparatus to:
receive, a request for additional computing resources during the predetermined time from an endpoint device of the endpoint device group;
analyze the request for the additional computing resources; and
re-scale, in response to the request for the additional computing resources, the allocated portion of the computing resources.

10. The computer program product of claim 8, wherein the code further causes the apparatus to:
receive news data from a news data feed, wherein the news data comprises an outage report;
re-scale the allocated portion of the computing resources based on the news data.

11. The computer program product of claim 8, wherein the code further causes the apparatus to:
cause to be displayed on an endpoint device of the endpoint device group, a dashboard, the dashboard displaying a computing resource usage rate for the application, endpoint device quantity, and a listing of other applications;
wherein computing resources are in a datacenter, and wherein the dashboard displays datacenter specific views and a utilization percentage of the datacenter; and
wherein the dashboard displays a regional breakdown of regional computing resource usage.

12. The computer program product of claim 11, wherein the dashboard displays server efficiency, and wherein computing resource allocation is modified based on the server efficiency.

13. The computer program product of claim 8, wherein scaling the allocated portion of the computing resources comprises at least one of (i) turning on or off processors of the computing resources, (ii) adding or removing route servers, and (iii) re-allocating computing resources to the application.

14. The computer program product of claim 8, wherein the metadata is at least partially provided by a work portal database.

15. A method for data driven scaling of computing resource allocation via machine learning, the method comprising:
receiving interaction data from each endpoint device within an endpoint device group, the interaction data comprising utilizing of an application, and metadata of at least one of a user identifier, time, location, role, weather, holidays, and current events, wherein the application utilizes an allocated portion of computing resources located at a server cluster, the allocated portion being specific to the application and scalable;
logging, in usage logs, the interaction data;
determining, from the usage logs, a usage pattern associated with the application, the usage pattern comprising extracted trends and an impact on the utilization of the application based on the extracted trends;
predicting, using the usage pattern, a predicted application usage for a predetermined time;
compiling the predicted application usage into a compiled application usage; and
scaling, at the predetermined time and based on the compiled application usage, the allocated portion of the computing resources.

16. The method of claim 15, the method further comprising:
receiving, a request for additional computing resources during the predetermined time from an endpoint device of the endpoint device group;
analyzing the request for the additional computing resources; and
re-scaling, in response to the request for the additional computing resources, the allocated portion of the computing resources.

17. The method of claim 15, the method further comprising:
receiving news data from a news data feed, wherein the news data comprises an outage report;
re-scaling the allocated portion of the computing resources based on the news data.

18. The method of claim 15, the method further comprising:
causing to be displayed on an endpoint device of the endpoint device group, a dashboard, the dashboard displaying a computing resource usage rate for the application, endpoint device quantity, and a listing of other applications;
wherein computing resources are in a datacenter, and wherein the dashboard displays datacenter specific views and a utilization percentage of the datacenter; and
wherein the dashboard displays a regional breakdown of regional computing resource usage.

19. The method of claim 18, wherein the dashboard displays server efficiency, and wherein computing resource allocation is modified based on the server efficiency.

20. The method of claim 15, wherein scaling the allocated portion of the computing resources comprises at least one of (i) turning on or off processors of the computing resources, (ii) adding or removing route servers, and (iii) re-allocating computing resources to the application.
